(19) United States
(12) Patent Application Publication
(10) Pub. No.: US 2016/0281686 A1
(43) Pub. Date: Sep. 29, 2016

(54) WIND POWERED BATTERY CHARGING SYSTEM FOR ELECTRIC VEHICLES

(71) Applicants: ABDUL HAKEEM, LUBBOCK, TX (US); AETIZAZ SAMEER, LUBBOCK, TX (US)

(72) Inventors: ABDUL HAKEEM, LUBBOCK, TX (US); AETIZAZ SAMEER, LUBBOCK, TX (US)

(21) Appl. No.: 15/070,079

(22) Filed: Mar. 15, 2016

Related U.S. Application Data
(60) Provisional application No. 62/136,628, filed on Mar. 23, 2015.

(51) Int. Cl. F03D 9/12; F03D 9/25; F03D 7/06; F03D 9/00; F03D 3/00; F03D 3/04

(52) U.S. Cl. CPC F03D 9/12; F03D 3/002; F03D 3/04; F03D 7/06; F03D 9/002; F03D 9/25

(57) ABSTRACT

A wind-powered system for charging batteries in an electric vehicle when the vehicle is moving at insufficient speed for a turbine to drive the generator or when the wind is insufficient to rotate the turbine. The turbine rotates about a horizontal axis and is rotatably engaged with flywheels, wherein the flywheels store mechanical energy while the vehicle is moving at a high speed. A control device receives input signals from an electric charge sensor and determines electric current produced by the generator to release mechanical energy from the flywheels to the turbine for driving the generator. The generator produces electricity which is stored on the batteries for the use of the vehicle.

### CROSS-REFERENCE TO RELATED APPLICATION

The present application is based on, and claims the benefit of priority of U.S. application Ser. No. 62/136,628, filed on Mar. 23, 2015, the disclosure of which is hereby incorporated by reference herein in its entirety.

### BACKGROUND OF THE INVENTION

1. Field of the Invention

The field of the invention is related to a system for generating electricity in an electric vehicle powered by a turbine and a generator for charging batteries when the vehicle is moving at insufficient speed for a turbine to drive the generator or when the wind is insufficient to rotate the turbine. The invention also relates to a control device to determine the electric charge produced by the generator for charging the batteries. The flywheels store the mechanical energy when the turbine rotates at a high speed and releases the energy at the low speed to maintain the momentum of the turbine when the wind or air flow is insufficient to rotate the turbine, and thereby enables the generator to generate stable and continuous electricity.

2. Description of the Prior Art

Travel distance for electrically powered vehicle is considerably short that requires the batteries to be recharged. Battery currently available charging system for electrically powered vehicles is significantly less efficient than the gasoline powered vehicles. Additionally, charging battery usually takes several hours, and the vehicle must remain inoperative.

Increasing the travel range of electric powered vehicles between downtimes for battery recharging can significantly increase the use of electrically powered vehicles. The range of electric powered vehicles can be increased by charging the batteries while the vehicle is in motion. This has typically been accomplished by utilizing wind or air flow as a durable power source.

Various prior arts have been provided for generating electricity for storage and use in powering electric-powered vehicles utilizing wind or air flow during the movement of the vehicle. These prior arts, however, are not adapted to generate electricity when the wind or air flow is insufficient for the generator to produce adequate electrical energy for charging batteries.

A need exists in the art for a wind powered battery charging system for generating electricity in electric-powered vehicles which overcomes this problem.

It is an object of this invention to provide an improved system for generating sufficient electrical energy to power a car by using flywheels to provide power for the wind turbine when the wind or air flow is insufficient.

### SUMMARY OF THE INVENTION

A preferred embodiment of the invention is a wind-powered battery charging system for generating electricity in an electric vehicle having a turbine rotatively secured in a turbine chamber by bearing blocks, a flywheel rotatively engaged with the turbine, a generator for generating electricity, and a device for storing electricity to operate the vehicle.

Still in the preferred embodiment, the flywheel rotatively engaged with the turbine for storing mechanical energy when excess energy is provided by the turbine to the generator and releasing energy when inadequate energy is provided by the turbine to the generator. When the vehicle is moving at insufficient speed or the wind is insufficient to rotate the turbine, the flywheel releases its stored mechanical energy to the turbine, thereby enabling the turbine to continue rotating. The flywheel enables the turbine to increase the momentum of the turbine and to maintain smooth rotation of the turbine to provide a more stable and continuous current flow for the generator to generate electricity.

Another preferred embodiment is a control device electrically connected to the turbine for releasing mechanical energy from the flywheel to the turbine only when the electric charge produced by the generator is below a predetermined value.

Still in the preferred embodiment, the control device is electrically connected to a forward opening of the vehicle having an adjustable flap for adjusting air flow into the turbine when the vehicle speed is high.

In another preferred embodiment, the turbine rotates in a horizontal axis about a turbine shaft having a turbine gear. The generator is operatively mounted on a generator shaft having a generator gear. The generator gear is operatively engaged with the turbine gear. Preferably, the turbine gear and the generator gear are each sized to optimize the rotational speed of its respective component, wherein the turbine gear is larger than the generator gear.

Another preferred embodiment of this invention is adapted to be embodied in a system for generating electricity in a vehicle, comprising storage device for storing electricity produced by the generator.

### BRIEF DESCRIPTION OF DRAWINGS

FIG. 1 is a top cutaway view of an electric vehicle showing installation of an embodiment of the invention.

FIG. 2 is an elevational view of a turbine, generator, flywheels, and gears according to an embodiment of the present invention.

FIG. 3 is a flow diagram showing the operation of the control device in accordance with the embodiment of the invention.

### DETAILED DESCRIPTION OF THE INVENTION

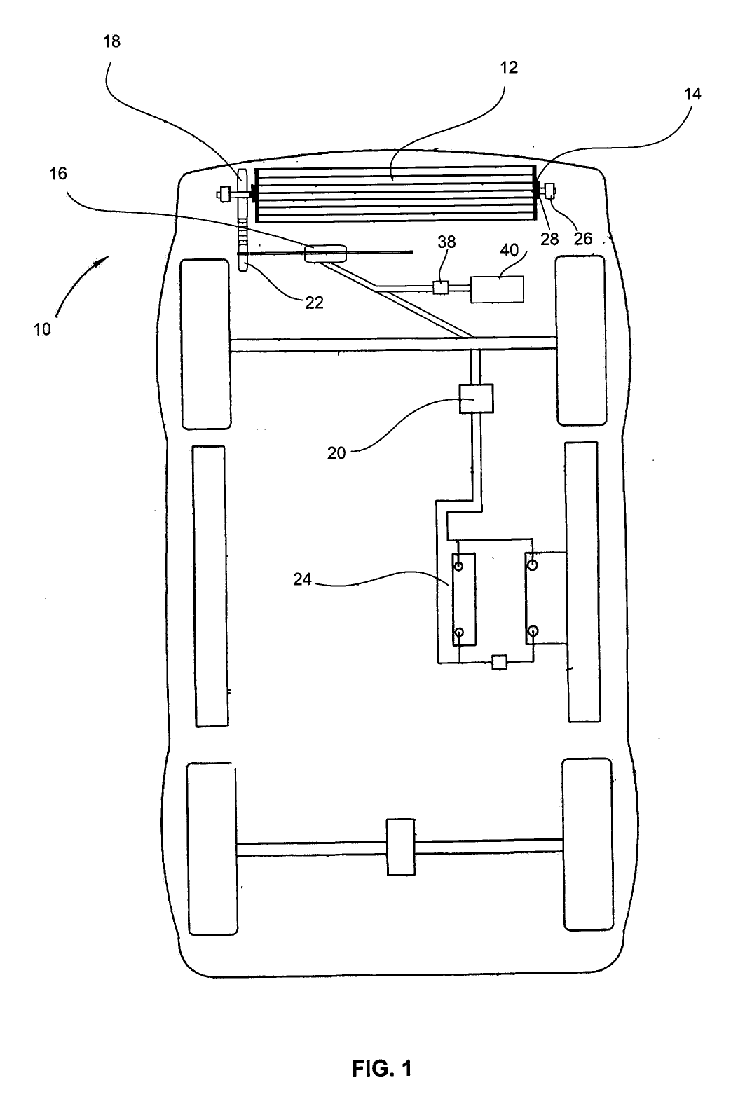

FIG. 1 shows a cutaway view of a vehicle 10 is shown. The vehicle 10 has a turbine 12, flywheels 14 rotatively engaged the turbine 12, and a turbine gear 18 operatively engaged with a lower gear 22. This lower gear 22 drives the generator 16 via a shaft to produce electricity which is used for charging batteries 24. The electricity produced by the generator 16 is also supplied to the to the AC motor 40 via the inverter 38 which converts the electric current to alternating current. If the vehicle can be powered with DC motor, the current for DC motor is supplied directly from the generator. Inverter is therefore not needed.

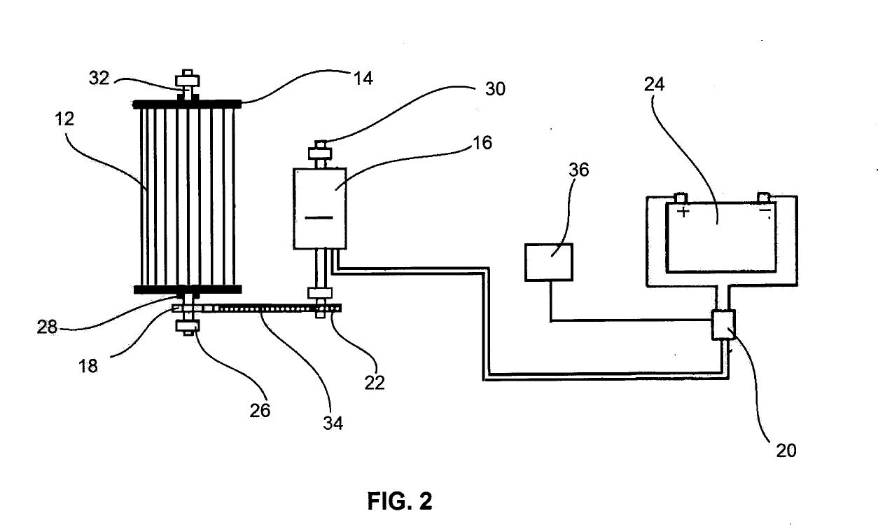

FIG. 2 shows an elevational view of the turbine 12, generator 16, flywheels 14, and batteries 24 according to an embodiment of the present invention. Still referring to FIG. 2, the turbine 12 operatively connected to a turbine shaft 32 rotates about a horizontal axis, which passes through the surfaces of turbine chamber 26 and is supported by bearing blocks 28. The bearing supports 28 are fastened to the vehicle for support. A turbine gear 18 is fastened to the turbine shaft 32.

Still referring to FIGS. 1 and 2, a turbine gear 18 is secured to the turbine shaft 32. A turbine belt 34 is rotatively engaged with the turbine gear 18 and a generator gear 22 to transfer rotational energy to the generator 16. As vehicle 10 is engaged in forward motion at a high speed, a portion of the rotational energy transfers to the turbine shaft 32, which in turn transfers to the flywheels 14. The flywheels 14 store mechanical energy in its rotation, while the generator 16 produces electrical energy for charging the storage batteries 24. As the vehicle 10 slows or stops, wind or air flow to the turbines 12 decreases, decreasing the rotational energy provided by the turbines 12 to the generator 16. Without the flywheels 14, the generator 16 would generating inadequate electric charge or stop generating electric charge for the batteries 24. However, the flywheels 14 continue to rotate when the vehicle 10 slows down or stops after being driven in a forward direction because mechanical energy had been stored in the rotation of the flywheel. This stored mechanical energy is transferred from the flywheels 14 to the turbine 12, enabling the turbine 12 to continue rotating so that provides power for the generator 16.

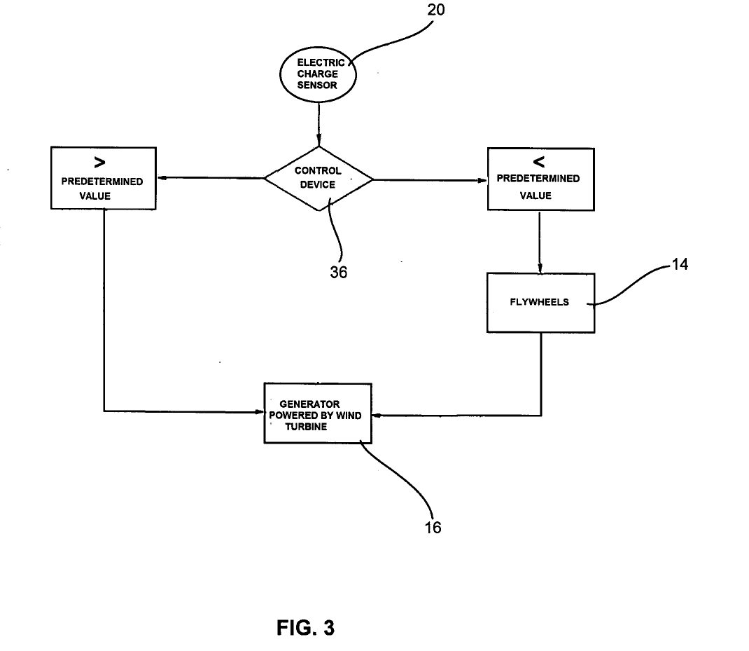

FIG. 3 illustrates the operation of the embodiment of the present invention in flow diagram form. Initially, the electric charge produced by the generator 16 is determined by the sensor 20. The control device 36 receives and analyzes input signals from the sensors 20. If the control device determines that the electric charge produced by the generator 16 is below a predetermined value because the rotational energy provided by the turbine 12 is insufficient to drive the generator 16, the flywheels 14 are automatically adjusted to discharge mechanical energy to enable the turbine 12 to continue rotating to drive the generator 16 for generating electricity. On the other hand, if the control device 36 determines that the electric charge is above the predetermined value because the rotational energy provided by the turbine 12 is sufficient to drive the generator 16, the flywheels 14 are not adjusted to discharge mechanical energy. In that case, the generator 16 continues to be powered directly by the rotational energy provided by the turbine 12.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A wind powered battery charging system for an electric vehicle, comprising:
(a) a mechanical energy storage that contains a plurality of flywheels;
(b) a turbine to be operated by an energy source selected from a group consisting of wind, air flow, mechanical energy provided by the mechanical energy storage, and any combination thereof;
(c) an electric generator powered by the turbine for producing electrical energy;
(d) electrical energy storage that contains a plurality of batteries electrically connected to the electric generator for receiving and storing electrical energy produced by the electric generator;
(e) an electric charge sensing device selected from a group of consisting of a current sensor, a voltage sensor, circuit breaker, and any combination thereof for sensing an electric energy produced by the generator; and
(a) a control device connected to the turbine and the mechanical energy storage for receiving signals from the electric charge sensing device and engaging the mechanical energy storage to release the mechanical energy to the turbine.

2. The system of claim 1, wherein the flywheels are rotatively engaged with the turbine for storing mechanical energy when the turbine accelerates at a high rotational speed and releasing mechanical energy when the turbine decelerates at a low rotational speed.

3. The system of claim 1, wherein the turbine rotates about a horizontal axis.

4. The system of claim 1, wherein the turbine rotates about a turbine shaft having a turbine gear.

5. The system of claim 1, wherein the electric generator is mounted on a generator shaft having a generator gear.

6. The generator gear of claim 5 is rotatively engaged with the turbine gear.

7. The system of claim 1, wherein the gear ratio between the turbine gear and generator gear is about ten.

8. The system of claim 1, wherein the electric charge sensing device is electrically connected to the electric generator for sensing an electrical charge produced by the generator.

9. The system of claim 1, wherein the control device is operatively engaged with mechanical energy storage for releasing mechanical energy to the turbine when the electrical charge sensed by the electric charge sensing device is below a predetermined value.

10. The control device of claim 9 is further operatively engaged with a forward opening having an adjustable flap for adjusting air flow into the turbine when the vehicle speed is high.
